(19) United States
(12) Patent Application Publication
(10) Pub. No.: US 2006/0255302 A1
(43) Pub. Date: Nov. 16, 2006

(54) Adjustment method and adjustment device for an actuator

(75) Inventors: Josef Aspelmayr, Ried/Riedmark (AT); Bernd Falke, Pentling (DE); Thomas Franz, Nurnberg (DE); Diego Lobus, Regensburg (DE); Walter Schrod, Regensburg (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT

(21) Appl. No.: 10/567,627

(22) PCT Filed: Jul. 13, 2004
(86) PCT No.: PCT/EP04/51467

§ 371 Date: Jul. 5, 2006

(30) Foreign Application Priority Data
Aug. 8, 2003 (DE) 103 36 606.7

(51) Int. Cl. F16K 31/02

(52) U.S. Cl. 251/129.06

(57) ABSTRACT

In an adjustment method and an adjustment device for an actuator of a valve, in particular for a piezoelectric actuator of an injection valve for an internal combustion engine, wherein the actuator is charged to various charge states, following a given control procedure, which each correspond to a position of the valve. The control procedure is regulated in dependence on a regulation parameter. The regulation parameter describes the charge state of the actuator and/or the valve position and, in addition, an external measured parameter, namely the pressure on the valve.

The invention relates to a control method and a control device for a valve actuator, in particular for a piezoelectric actuator of an injection valve for an internal combustion engine, according to the preambles of claims 1 and 8.

In modern injection systems for internal combustion engines, piezoelectric actuators are used as the final positioning elements for injection valves, allowing highly dynamic control of the injection process compared to conventional solenoid valves. The stroke of a piezoelectric actuator of this kind and therefore the valve position of the associated injection valve depends on the charge state, which means that the piezoelectric actuator must be charged or discharged according to the required stroke.

In order to optimize the combustion process in an internal combustion engine, it is desirable that the fuel can be subdivided into several portions in a working cycle of the internal combustion engine. In order to be able to produce several pre-injections of very small amounts of fuel followed by a main injection as well as, if required, several post-injections in rapid succession using a piezoelectric actuator, the actuator must charge or discharge very rapidly to different charge states. Between the individual injections of a working cycle it must be possible for the actuator not to discharge completely, i.e. for the valve to be held in a minimally open position in order to allow a quicker response of the actuator to the next triggering and in order to avoid pressure gradients in the injector which would make a rapid succession of injections impossible.

It is additionally desirable that the actuator can be charged or discharged up to a particular stroke via intermediate positions in which the valve is partially open in order to eliminate noise interference and vibration as far as possible and to minimize actuator or valve wear.

For the electrical triggering of piezoelectric actuators according to the required stroke, DE 199 44 733 A1 discloses a driver circuit with a transformer in which the primary side of the transformer is connected to a supply voltage via a charging switch, whereas the secondary side is connected to the piezoelectric actuator via a discharging switch. By means of suitable pulse width modulated triggering of the charging switch and discharging switch, the charge state of the piezoelectric actuator can be adjusted according to the desired valve position so that the injection valve opens or closes at the specified times. For triggering a particular actuator stroke for opening the valve to an intermediate state in which it is partially open, an actuator characteristic is taken into account which represents a relationship between the charge applied to the actuator and the stroke of the actuator.

Although triggering the actuator to a particular stroke is possible with this method, the actuator must be completely discharged before the next opening cycle of the valve, the valve being closed in order to re-attain a defined initial state. This is necessary, as the actuator does not follow the same characteristic for discharging as for charging. The reasons for this are, for example, the system hysteresis of the actuator or parasitic resistances.

The object of the invention is therefore to precisely trigger piezoelectric injection valves in immediate and rapid succession to any required strokes in order to allow optimum injection sequences. It shall be possible to achieve these strokes via any triggering paths in order to be able to minimize noise emissions, vibration and wear.

This object is achieved by a control method and control device for a piezoelectric actuator according to claims 1 and 8 respectively.

The invention is based on the physical knowledge that an actuator characteristic can be used not only for charging the piezoelectric actuator but also for discharging it, the actuator characteristics being linked via the system hysteresis. This means that it is possible, from any valve position, to directly trigger any other valve position. In order to enable this, the actuator characteristics and the hysteresis of the actuator must be precisely known in order to regulate the controller. The invention makes use of the knowledge that the actuator characteristics assumed by the controller and the actual hysteresis can change during operation.

The control method according to the invention charges or discharges the actuator to different charge states, each corresponding to a valve position, the charging or discharging being controlled according to a specified control action corresponding to a specified setpoint value for the charge state. The control action is regulated as a function of a controlled variable reflecting the actuator's charge state and/or the valve position.

The control action can basically be regulated as a function of at least one controlled variable, the abovementioned variables being only examples. Thus regulation in combination with various other controlled variables is also conceivable.

The variables determined as part of regulation are preferably compared with a setpoint value. Thus the deviation of the measured valve position from the desired position, i.e. the deviation of the last charging/discharging process from the setpoint, can be used to match the parameters of the actuator characteristics used to the physical properties of the actuator and, moreover, the setpoint/actual deviation can be compensated in the next charging/discharging process.

The controlled variable is preferably determined in an idle time between two consecutive chargings or dischargings, any possible idle period between the triggering of different charge states being conceivable as a suitable time. This is advantageous, as it ensures that determination of the controlled variable does not take place in the time-critical range of the triggering. During high-speed triggering, precise measurement is in some cases difficult.

Advantageously the control action is also adjusted in an idle time between two successive chargings or dischargings. This means that the triggering of a required charge state can take place extremely rapidly, as no regulation is necessary during triggering. The control action, in particular the actuator characteristic and the hysteresis, can be recalculated in an idle period within the time available.

In an advantageous embodiment, the control method is so designed that the actuator can also be charged and/or discharged to charge states corresponding to a partially open valve position. With the partial opening of the valve, pre-injections can be performed. It is additionally advantageous if, during triggering of the completely open state, intermediate states are attained at which the valve is held for a while in order to prevent noise and minimize vibration. By means of such a graduated opening or closing of the injection valve, the flow-dynamic processes can also be optimized for the injection process, an advantage of the control method according to the invention being that the valve position is still precisely known even after the triggering of a plurality of intermediate states (charging/discharging).

The voltage across the actuator or the actuator charge are preferably used as controlled variables. These variables can be determined in different ways. For example, the actuator voltage can be tapped off directly or also measured relative to a reference level if the actuator is terminated to ground with a resistor. The actuator charge can be obtained, for example, from the integral of the current pulses applied, both charging and discharging current having to be taken into account. However, other variables such as the actuator temperature are conceivable as controlled variables.

Advantageously the control action for charging is determined by a specified charging characteristic. The charging characteristic can represent, for example, a relationship between the charge to be applied and the charging time. The greater the charge to be applied, the greater the charging time if the pulses are of constant frequency. This relationship is in some cases non-linear if, for example, the magnitude of the current pulses decreases with increasing actuator charge. However, the charging characteristic can also represent a relationship between the charge to be applied and the number of pulses with which the actuator is charged, other relationships also being possible. The same also applies to the discharging processes, even if these are preferably determined by one or more different discharging characteristics. This allows the required valve positions to be triggered with high and adjustable speed. In addition, the charging/discharging process can be advantageously adjusted over time in a charging/discharging curve. For example, it is defined in the charging curve that the valve initially accelerates relatively slowly during the charging process and is decelerated relatively slowly at the end of the charging process, but is moved at high speed in between. Speeds of this kind which are variable via the charging/discharging process can be preferably controlled using pulse width modulation of the charging pulses. This can serve to prevent high pressure gradients. Various charging curves can also be used for different charging/discharging processes. By suitably selecting the shapes of the charging curves, noise emission, vibration excitation and wear during operation can be reduced. The charging/discharging characteristics, the actuator characteristics, the hysteresis and the charging curves can be retrievably stored in a memory unit.

The controller can be regulated via a variation in the steepness of the charging/discharging characteristic. This could mean, for example, that for a particular charge to be applied, corresponding to a particular travel, more charge is applied per pulse. This can be advantageously adjusted using pulse width modulation of the current pulses. Similarly, the actuator characteristics and the charging curves can also be varied.

Alternatively, however, it is also conceivable to vary the shape of the charging/discharging characteristic. In precisely the same manner, the shapes of the actuator characteristics and charging curves can also be varied.

The control action can also be determined by the charging duration and/or discharging duration of a charging/discharging process. If, for example, the actuator is charged at constant frequency with pulses of the same magnitude, a higher charge which is applied in a process can be adjusted by a lengthening of the charging duration corresponding to an increase in the number of pulses applied per charging process. By shortening the charging duration, the applied charge of a charging process is reduced. This applies analogously to the discharging process. In addition to the abovementioned possibilities for regulating the controller, other possibilities correspond to the inventive idea. In particular, combinations of the abovementioned regulation options can be used.

In a particularly advantageous variant of the invention, external measured variables are also acquired for regulation. The term measured variables here refers to measured quantities outside the region of the actuator and its associated driver circuit. This can be, for example, the pressure at the injector or another measured variable from the region of the internal combustion engine. As the pressure at the valve can affect the actuator characteristic, it is advantageous if the controller is regulated taking this variable into account. However, other controlled variables are also conceivable.

Advantageously, the coolant temperature of the internal combustion engine or the oil temperature of the internal combustion engine are taken into account as external measured variables for regulating the controller.

Many different variables affect the hysteresis behavior and the characteristics of the actuator, for which reason it may be advantageous also to use measured variables other than those mentioned here for regulation of the controller.

Associated with the control method is an inventive control device for controlled charging and/or discharging of an actuator of the valve to specified charge states using a specified control action. For adapting the control action, the control device preferably has a regulator which is connected on the input side to the actuator or the valve, the controlled variable reflecting the charge state of the actuator and/or the valve position. Setpoint/actual deviations can be determined thereby and used for regulation. The regulator preferably has a memory unit in which previous charging processes and deviations are stored so that even information from earlier charging or discharging operations can be taken into account for regulation.

Advantageously, a regulator using one of the determined controlled variables and/or the setpoint/actual deviations of a controlled variable as input variable is superimposed on the controller of the charging processes.

The regulator preferably uses idle times for discontinuous acquisition of the controlled variable and/or discontinuous adjustment of the control action.

It is also advantageous to connect a sensor for acquiring the oil temperature or the coolant temperature of the vehicle to the regulator so that the latter can use one or more of these variables as controlled variables. These are only examples, input-side connection of the regulator to other sensors for acquiring other controlled variables may also be useful.

Although the control method according to the invention lends itself in a particularly advantageous manner to pump-nozzle injection systems, the invention is also implementable with common-rail injection systems. In addition, the invention can also be used for gasoline direct injection (HPDI—High Pressure Direct Injection).

Other advantageous developments of the invention are contained in the dependent claims or are explained below together with the description of the preferred exemplary embodiments of the invention with reference to the accompanying drawings, in which:

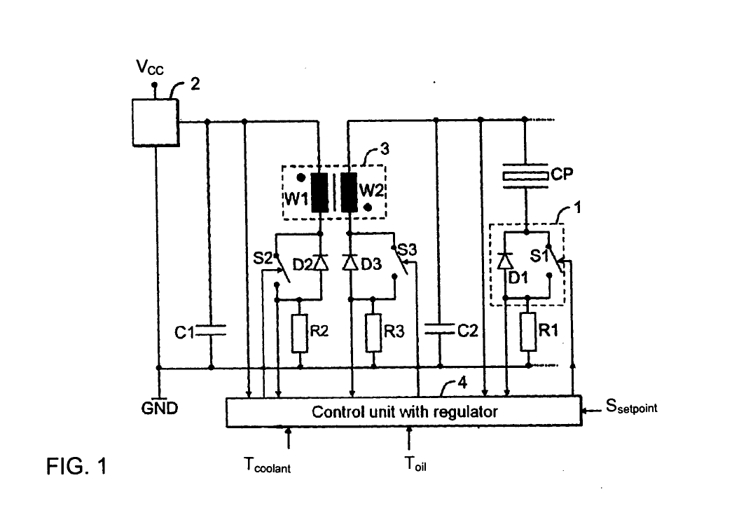

FIG. 1 shows a circuit diagram of a conventional driver circuit for electrical triggering of a piezoactuator with the control device according to the invention,

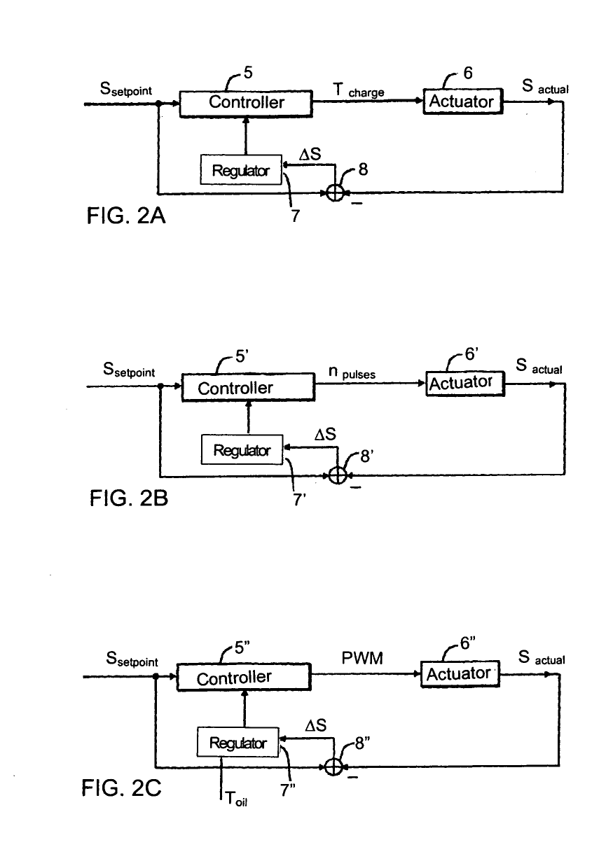

FIGS. 2a-2c show three exemplary regulation diagrams for the control unit from FIG. 1 and

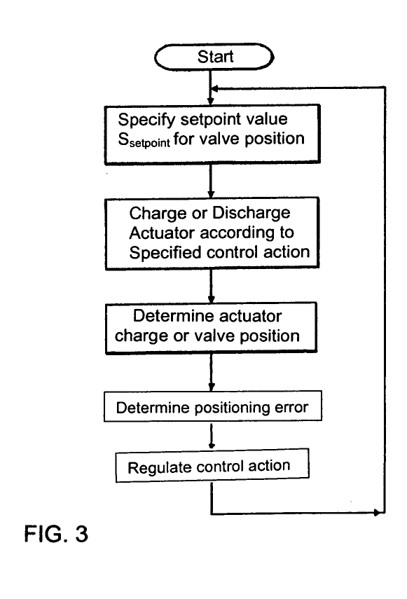

FIG. 3 shows the control method according to the invention as a flowchart.

The driver circuit shown in FIG. 1 is used for electrically triggering piezoelectric actuators of injection valves of an internal combustion engine, only one actuator CP being shown for simplicity's sake, even though a plurality of actuators corresponding to the number of combustion chambers are present in a multi-cylinder internal combustion engine. The actuators not shown are, however, of identical design and connected in parallel with the actuator CP, as indicated by the dashed lines.

The actuator CP—like the other actuators (not shown) for the other combustion chambers of the internal combustion engine—are connected in series with a selector switch 1 and a resistor R1, the selector switch 1 consisting of a switching element S1 and a diode D1 connected in parallel. The selector switch 1 enables one of the actuators to be selected for a charging or discharging operation by through-connecting the relevant switching element S1 while the corresponding switches for the other actuators disconnect.

Power is supplied to the driver circuit by a voltage transformer 2 which is buffered on the output side by a capacitor C1 and, when used in a motor vehicle, is supplied with V_{cc}=12V from the vehicle electrical system.

Alternatively, the invention can also be used in a 42V vehicle electrical system.

Between the actuator CP and the voltage transformer 2 there is disposed a transformer 3 with a primary winding W1 and a secondary winding W2, the primary winding W1 being connected to the voltage transformer 2, whereas the secondary winding is connected to the actuator CP.

The primary winding W1 of the transformer 3 is connected in series with a resistor R2 and a parallel circuit comprising a diode D2 and a charging switch S2. To charge the final control element, the charging switch S2 is triggered, for example, with specified frequency and specified duty factor in pulse mode using a specified number of pulse width modulated signals for the specified charging voltage. Alternatively, the charging switch S2 can also be triggered, for example, with variable frequency. During the conducting state of the charging switch S2, the current through the primary winding W1 increases and is cut off at a specified time by the charging switch S2 being opened (rendered nonconducting). In this nonconducting phase of the primary side, there flows across the secondary winding W2, in the case of a current corresponding to the turns ratio W2/W1, a pulse-shaped voltage which is smoothed by a capacitor C2 and which continues to charge the actuator CP with each current pulse until finally, after the specified number of pulses, a specified actuator voltage is approximately achieved. During charging of the actuator CP, the secondary circuit is closed via the selector switch 1.

The secondary winding W2 of the transformer 3, on the other hand, is connected in series with a resistor R3 and a parallel circuit comprising a diode D3 and a switch S3.

The actuator CP is likewise discharged by the discharging switch S3 being rendered impulsively conducting and nonconducting, thereby causing the actuator voltage to fall, the current flowing from the actuator CP via the secondary winding W2, the discharging switch S3 and the selector switch 1 back to the actuator CP.

Each time the discharging switch S3 opens, part of the discharging energy is transmitted to the primary side of the transformer 3 and re-stored in the charging capacitor C1. The primary circuit is completed via the diode D2.

The selector switch 1, the charging switch S2 and the discharging switch S3 are triggered by a control unit 4 which is only illustrated schematically here.

In the version shown, said control unit 4 takes account of the charging current, the discharging current, the actuator current, the actuator voltage, the primary-side voltage as well as external controlled variables such as the oil temperature Tₒᵢₗ and the coolant temperature T_{coolant}. The control unit 4 therefore has a plurality of measurement inputs which are connected to the voltage-side terminals of the resistors R1, R2 and R3 and to the voltage-side terminals of the primary winding W1 or secondary winding W2 and to sensors for determining the other abovementioned variables.

By way of example, FIGS. 2a to 2c show simple embodiments of the regulating circuit of the control unit 4 from FIG. 1. The controller 5 receives a setpoint value Sₛₑₜₚₒᵢₙₜ for the actuator position which corresponds to a valve position. The control unit charges or discharges the actuator 6 via the driver circuit from FIG. 1 with a specified charging characteristic corresponding to the setpoint value Sₛₑₜₚₒᵢₙₜ. For this purpose the controller 5 in FIG. 2a uses an actuator characteristic which represents a relationship between the travel and the charge to be applied and a charging characteristic which represents a relationship between the charge to be applied and the charging time T_{charge}. After the charging/discharging process, the actuator 6 reaches the actuator position S_{actual} which approximately corresponds to the target Sₛₑₜₚₒᵢₙₜ. The difference AS between Sₛₑₜₚₒᵢₙₜ and S_{actual} is used by a regulator 7 to adapt parameters of the controller 5, in particular to adapt the actuator characteristic used to the actuator behavior determined. For example, the same specified actuator travel is triggered in one of the following charging/discharging processes with another charge and correspondingly another charging time T_{charge}.

FIG. 2b shows another simple regulating circuit. It largely corresponds to that in FIG. 2a, except that the controller 5′ here uses a charging characteristic representing a relationship between the number n of pulses with which the actuator 6′ is triggered during a charging/discharging operation and the specified charge.

In FIG. 2c, the actuator 6″ is charged/discharged using pulse width modulated current pulses, thereby enabling not only the steepness of the charging characteristic or the duration of the charging process but also the shape of the charging characteristic to be influenced by the regulator 7′. In addition, an input for an external sensor signal is shown here by way of example. To regulate the controller, the regulator 7″ also takes into account the oil temperature Tₒᵢₗ of the vehicle containing the control unit.

FIG. 3 contains a schematic flowchart of the control method according to the invention. A setpoint value Sₛₑₜₚₒᵢₙₜ is specified for the valve position. The controller 5, 5′, 5″ charges/discharges the actuator CP, 6, 6′, 6″ according to the setpoint value Sₛₑₜₚₒᵢₙₜ using an actuator characteristic which creates a relationship between the required travel and the charge to be applied (positive or negative). With the charge thus determined for the travel, the actuator CP, 6, 6′, 6″ is charged or discharged according to a specified charging/discharging characteristic, preferably using pulse width modulated current pulses. The position S_{actual} actually reached by the valve is determined directly or from another variable such as the actuator charge. The positioning error is determined by comparing the setpoint value Sₛₑₜₚₒᵢₙₜ with the actual value S_{actual}. Said error is used to re-adjust the control action of the control unit. External controlled variables can also be taken into account here. The re-adjusted control action takes effect the next time the actuator CP 6, 6′, 6″ is charged or discharged to a new setpoint value Sₛₑₜₚₒᵢₙₜ.

The invention is not limited to the preferred exemplary embodiment described above. In fact a large number of variants and modifications are possible which likewise make use of the inventive idea and therefore fall within the scope of protection.

1-9. (canceled)

10. A control method for a valve actuator, which comprises the following steps:
selectively charging and discharging the actuator to various charge states, each corresponding to a valve position;
controlling the charging and discharging according to a specified control action corresponding to a specified setpoint value for the charge state;
during an idle time between two consecutive chargings or dischargings, determining a controlled variable reflecting the charge state of the actuator and/or a valve position;
acquiring an external measured variable in the form of a pressure at the valve; and
during an idle time between two consecutive chargings or dischargings, regulating the control action in dependence on the controlled variable and, additionally, on the external measured variable.

11. The control method according to claim 10, which further comprises charging and discharging the actuator to charge states corresponding to a partially open valve position.

12. The control method according to claim 10, which comprises determining the controlled variable by measuring a voltage across the actuator and/or a charge of the actuator.

13. The control method according to claim 10, which comprises determining the control action for charging by a specified charging characteristic, determining the control action for discharging by a specified discharging characteristic, wherein the charging characteristic and the discharging characteristic have a specified shape and steepness.

14. The control method according to claim 13, which comprises adjusting the steepness of the charging characteristic and/or of the discharging characteristic as part of the regulating step.

15. The control method according to claim 13, which comprises adjusting the shape of the charging characteristic and/or of the discharging characteristic as part of the regulating step.

16. The control method according to claim 10, which comprises determining the control action by the charging duration and/or the discharging duration, wherein the charging duration and/or the discharging duration are adjusted as part of the regulating step.

17. The control method acording to claim 10, wherein the valve actuator is a piezoelectric actuator and the valve is an injection valve for an internal combustion engine.

18. The control method according to claim 10, wherein the regulating step is a closed-loop control step.

19. A control device for at least one valve actuator, the control device comprising:
a controller for controlled charging and/or discharging of the valve actuator to specified charge states corresponding to a specified setpoint value, with each each of the charge states corresponding to a valve position and said controller being characterized by a specified control action; and
a closed-loop control regulator connected to said controller for adapting the control action of said controller;
said regulator having an input connected to the actuator and/or to the valve in order to acquire a first controlled variable;
the controlled variable reflecting a charge state of the actuator and/or a valve position; and
said regulator being configured to acquire the controlled variable discontinuously during idle times in each case and adjusting the control action discontinuously in idle times in each case;
said regulator having an input connected to at least one sensor for detecting a pressure at the valve defining a second controlled variable;

20. The device according to claim 19, wherein said regulator is superimposed on said controller.

21. The device acording to claim 19, wherein the valve actuator is a piezoelectric actuator and the valve is an injection valve of an internal combustion engine.
